(19) United States
(12) Patent Application Publication
(10) Pub. No.: US 2012/0169641 A1
(43) Pub. Date: Jul. 5, 2012

(54) TOUCH SENSING APPARATUS

(76) Inventors: Chien-Kuo Wang, Zhubei City (TW); Chien-Yu Chan, Hsinchu City (TW)

(21) Appl. No.: 13/343,432

(22) Filed: Jan. 4, 2012

(30) Foreign Application Priority Data
Jan. 4, 2011 (TW) 100100189

(51) Int. Cl. G06F 3/041

(52) U.S. Cl. 345/173

(57) ABSTRACT

A touch sensing apparatus includes a logic control module, a plurality of storage capacitors, at least one decoding control module, and at least one differential amplifier. The logic control module generates a plurality of control signals having different control timings, wherein the control signals comprise a decoding control signal. The decoding control module is coupled with the logic control module and the storage capacitors and decodes according to a decoding control timing of a decoding control signal and outputs a first sensing voltage and a second sensing voltage of the storage capacitors. The differential amplifier is coupled with the decoding control module and calculates a voltage variance between the first sensing voltage and the second sensing voltage to output an amplified analog data.

### BACKGROUND OF THE INVENTION

1. Field of the Invention

The present invention relates generally to a liquid crystal display; particularly, the present invention relates to a mutual capacitance touch sensing apparatus simultaneously sensing a plurality of analog data from a conductive thin film sensor and utilizing a differential amplifier to operate the analog data to minimize the load that the logic control module operates a plurality of digital data.

2. Description of the Prior Art

As technology rapidly advances, conventional displays are progressively replaced by thin film transistor liquid crystal displays (TFT LCDs). TFT LCDs are widely used in TVs, flat displays, cell phones, tablet PCs, projectors, and other relevant electronic devices. For TFT LCDs having touch function, touch sensors play an important role among all other modules, and performance of the touch sensor affects the overall performance of LCD.

Generally, the conventional LCD having mutual capacitance touch sensing function includes a display panel, a conductive thin film sensor (e.g. ITO sensor), and a touch control chip, wherein the conductive thin film sensor includes a plurality of sensing lines and a plurality of driving lines, and the touch control chip includes a plurality of pins. The sensing lines are coupled with the pins respectively. When the driving line transmits a driving pulse to couple a small voltage at the sensing line, the touch control chip will sense the coupled voltage and determine according to the magnitude of the coupled voltage whether the conductive thin film sensor is touched.

However, the touch sensing method of the conventional liquid crystal display has some serious drawbacks. For example, the scanning rate is too slow; the noise generated by the display panel seriously affects the operation of the touch control chip. In a worse case, the noise may cause the misjudgment of the location of the touch point. In order to avoid the noise generated by the panel, in some systems, an isolating layer is disposed between the conductive thin film sensor and the panel. However, such an approach inevitably increases the cost and the thickness of the whole device, impairing the mechanical design of device.

Hence, the present invention provides a touch sensing apparatus which can solve the problem.

### SUMMARY OF THE INVENTION

The present invention provides a touch sensing apparatus. In an embodiment, the touch sensing apparatus includes a logic control module, a plurality of storage capacitors, at least one decoding control module, and at least one differential amplifier. The logic control module generates a plurality of control signals having different control timings, wherein the control signals comprise a decoding control signal. One of the storage capacitors at least stores a first sensing voltage and a second sensing voltage, wherein the first sensing voltage and the second sensing voltage are analog data respectively sensed through a first sensing line and a second sensing line of a conductive thin film sensor. The decoding control module is coupled with the logic control module and the storage capacitors, wherein the decoding control module decodes according to a decoding control timing of the decoding control signal and outputs the first sensing voltage and the second sensing voltage. The differential amplifier is coupled with the decoding control module, wherein the differential amplifier calculates a voltage variance between the first sensing voltage and the second sensing voltage to output an amplified analog data.

In practical applications, the touch sensing apparatus further includes a plurality of pins, at least one driving/sensing control module, and at least one storage control module. The logic control module generates the control signals having different control timings according to an external synchronization signal, so that the pins sense in a time period that a liquid crystal display panel does not generate noise during the pins sensing. The logic control module comprises a digital filter for filtering the digital data to lower influence from a noise. In addition, the logic control module can generate the control signals having different control timings without the external synchronization signal, so that the digital filter filters noise generated from the liquid crystal display panel during the pins sensing.

The driving/sensing control module is coupled with the logic control module and the pins, wherein the driving/sensing control module receives a driving/sensing control signal of the control signals from the logic control module and controls the pins to execute a plurality of pin functions according to a driving/sensing control timing of the driving/sensing control signal, so that the pins sense the first sensing voltage and the second voltage from the first sensing line and the second sensing line of the conductive thin film sensor. The storage control module includes the storage capacitors, wherein the storage control module is coupled with the logic control module and stores the first sensing voltage and the second sensing voltage in the one of the storage capacitors according to a storage control timing of a storage control signal of the control signals.

Compared to the prior arts, the touch sensing apparatus of the present invention simultaneously stores the analog sensing voltages sensed through the conductive thin film sensor in different storage capacitors, and the differential amplifier compares the analog sensing voltages of adjacent channel corresponding to different storage capacitors, so that the touch accuracy of the touch sensing apparatus increases according to the compared result of the sensing voltage. Moreover, the touch sensing apparatus of the present invention further utilizes the control signals having different control timings to perform the sensing process in a time period that the LCD panel does not generate noise, so that the misjudgment of the location of touch point due to the influence of the noise of liquid crystal display panel on the sensed data can be avoided.

In addition, because the conventional touch LCDs doesn't operate the analog data in the analog end, until the analog data is converted into the digital data, and then the logic control module operates the digital data, so that the load of the logic control module is too heavy. Hence, the touch sensing apparatus of the present invention utilizes the differential amplifier in the analog end operating the analog data to minimize the error of the analog data. When the analog data is amplified and is converted into the digital data, the accuracy of the digital data increases, so that the load of the logic control module decreases, further increasing the touch accuracy of the touch sensing apparatus.

The detailed descriptions and the drawings thereof below provide further understanding about advantage and the spirit of the present invention.

### BRIEF DESCRIPTION OF THE DRAWINGS

FIG. 1 illustrates a schematic view of a touch sensing apparatus 1 for sensing the touch point on a display panel; and

FIG. 2 illustrates a schematic view of the internal circuit of the touch sensing apparatus 1 of the present invention.

### DETAILED DESCRIPTION OF THE PREFERRED EMBODIMENT

One embodiment according to the present invention is a touch sensing apparatus. In the present embodiment, the touch sensing apparatus is a differential inputting mutual capacitance touch sensing apparatus capable of sensing a plurality of data simultaneously through the conductive thin film sensor and avoiding the misjudgment of the location of touch point due to the influence of the noise of liquid crystal display panel on the sensed data.

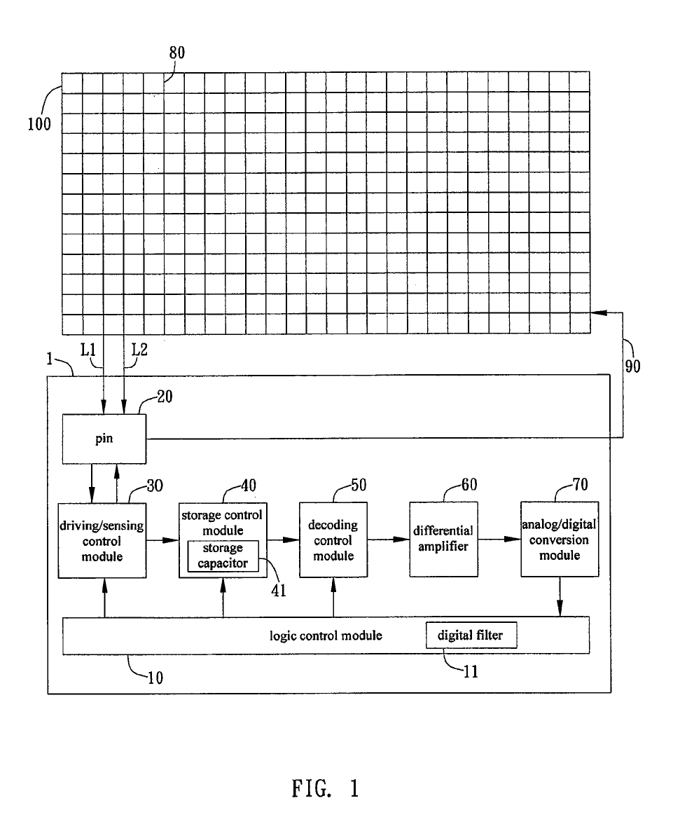

Please refer FIG. 1. FIG. 1 illustrates a schematic view of a touch sensing apparatus 1 for sensing the touch point on a display panel. As shown in FIG. 1, a liquid crystal display (LCD) panel includes a conductive thin film sensor 100 and the touch sensing apparatus 1. The LCD panel is generally attached to the bottom of the conductive thin film sensor 100, but the location of the LCD panel is not limited to the embodiment. The touch sensing apparatus 1 includes a logic control module 10, a plurality of pins 20, at least one driving/sensing control module 30, at least one storage control module 40, at least one decoding control module 50, at least one differential amplifier 60, and an analog/digital conversion module 70. The driving/sensing control module 30 is coupled with the logic control module 10 and the pins 20. The storage control module 40 is coupled with the logic control module 10 and the driving/sensing control module 30. The decoding control module 50 is coupled with the logic control module 10 and the storage control module 40. The analog/digital conversion module 70 is coupled with the differential amplifier 60 and the logic control module 10.

In the present embodiment, the logic control module 10 generates a plurality of control signals having different control timings, wherein the control signals comprise a decoding control signal. For example, the logic control module 10 can generate a driving/sensing control signal, a decoding control signal, and a storage control signal respectively having a driving/sensing control timing, a storage control timing, and a decoding control timing for controlling the driving/sensing control module 30, the storage control module 40, and the decoding control module 50, but not limited thereto.

The driving/sensing control module 30 receives the driving/sensing control signal of the control signals from the logic control module 10 and controls the pins 20 to execute a plurality of pin functions according to a driving/sensing control timing of the driving/sensing control signal, so that the pins 20 sense the first sensing voltage and the second voltage from the first sensing line L1 and the second sensing line L2 of the conductive thin film sensor 100.

In practical applications, the logic control module 10 generates the control signals having different control timings according to the external synchronization signal, so that the pins 20 sense in a time period that the liquid crystal display panel does not generate noise during the pins 20 sensing. In addition, the logic control module 10 can generate the control signals having different control timings without the external synchronization signal, so that the pins 20 sense in a time period that the liquid crystal display panel does not generate noise to avoid the analog data sensed by the pins 20 to be influenced by the noise of the LCD panel.

In the present embodiment, the storage control module 40 has a plurality of storage control capacitors 41. The storage control module 40 simultaneously stores the analog data (sensing voltage) in different storage capacitors 41 according to the storage control timing of the storage control signal of the control signals.

In is noted that, because each storage control module 40 includes the plurality of storage capacitors 41, the touch sensing apparatus 1 can sense the analog data simultaneously, and the plurality of analog data sensed by the sensing lines 80 can be simultaneously stored in different storage capacitors 41.

After the storage control module 40 stores the plurality of analog data in the storage capacitors 41, the conductive thin film sensor 100 will execute a discharge process, avoiding the residual charge of the conductive thin film sensor 100 to influence the sensing accuracy of the pins 20.

The decoding control module 50 receives the decoding control signal of the logic control module 10 and decodes different analog data (sensing voltage) stored in the storage capacitors 41 according to the decoding control timing of the decoding control signal. It is noted that, in the present invention, each decoding control module 50 simultaneously operates the analog data (sensing voltage) stored respectively in corresponding storage capacitors 41. After decoding the analog data, the decoding control module 50 outputs the first sensing voltage and the second voltage from the first sensing line L1 and the second sensing line L2 stored in the storage capacitors 41 to a positive input end and a negative input end of the differential amplifier 60.

The positive input end and the negative input end of the differential amplifier 60 respectively receive the first sensing voltage and the second sensing voltage, and the differential amplifier 60 compares the first sensing voltage with the second sensing voltage and calculates a voltage variance between the first sensing voltage and the second sensing voltage to output an amplified analog data. The analog/digital conversion module 70 converts the amplified analog data into a plurality of digital data and transmits the digital data to the logic control module 10. The logic control module 10 utilizes the digital filter 11 for filtering the digital data to lower influence from a noise.

In the present embodiment, the differential amplifier 60 compares and amplifies the analog data decoded by the decoding control module 50; the analog/digital conversion module 70 converts the amplified analog data into the digital data. In practice, the differential amplifier 60 can be an arbitrary type of differential amplifier; the analog/digital conversion module 70 can be an arbitrary type of analog/digital converter. However, the differential amplifier 60 and the analog/digital conversion module 70 are not limited to the embodiment.

It is noted that, the pins 20 included in the touch sensing apparatus 1 have more than one function and can switch between different functions based on practical requirements. Examples of the functions include, but are not limited to, driving function, sensing function, ground function, or floating function. In the conventional touch sensing apparatus utilizing the differential amplifier, each pins 20 has two sensing function, wherein one sensing function is coupling the sensing voltage with the positive input end of the differential amplifier 60, the other sensing function is coupling the sensing voltage with the negative input end of the differential amplifier 60. However, each pin 20 of the present invention just has one sensing function, and the touch sensing apparatus 1 controls a plurality of timings of internal storage capacitors, storage switches, buffer switches, positive input switches, and negative input switches to couple the sensing voltage with the positive input end and the negative input end of the differential amplifier 60, so the sensing function of each pin 20 of the present invention is less than the sensing function of each pin 20 of the conventional touch sensing apparatus utilizing the differential amplifier, further minimizing the area of the control chip effectively and the cost of the control chip.

As shown in FIG. 1, the conductive thin film sensor 100 includes a plurality of sensing lines 80 and a plurality of driving lines 90, wherein the driving lines 90 are arranged perpendicular to the sensing lines 80. It is noticed that the driving lines 90 and the sensing lines 80 can be interchanged with each other; in other words, the driving lines 90 shown in FIG. 1 can be also used as the sensing lines, and the sensing lines 80 shown in FIG. 1 can be also used as the driving lines, wherein the arrangement of sensing lines and driving lines can be controlled by the touch sensing apparatus 1. In the present embodiment, different pins 20 can respectively scan at a driving line 90 and sense a plurality of sensing lines 80 simultaneously, so that a plurality of analog data can be sensed. The logic control module 10 of the touch sensing apparatus 1 can control a specific pin 20 of the pins 20 to execute the sensing process at a specific timing.

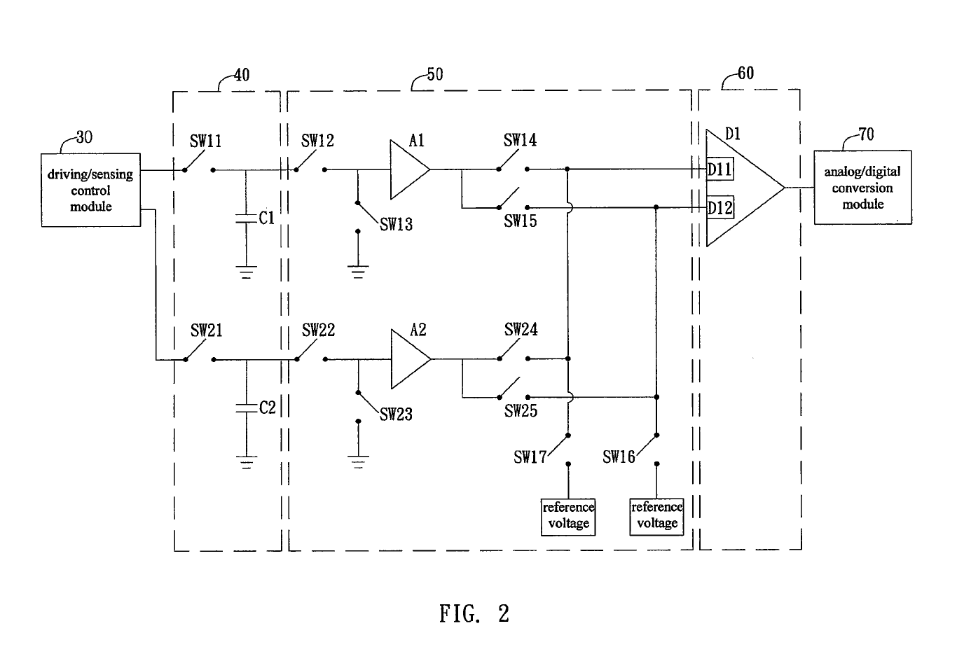

Please refer to FIG. 2. FIG. 2 illustrates a schematic view of the internal circuit of the touch sensing apparatus 1 of the present invention. It is noticed that, FIG. 2 illustrates one driving/sensing control module 30, the storage control module 40, the decoding control module 50, the differential amplifier 60, and the analog/digital conversion module 70 of the touch sensing apparatus 1. As shown in FIG. 2, the storage control module 40 includes storage switches SW11/SW21 and storage capacitors C1/C2; the decoding control module 50 includes buffer switches SW12/SW22, ground switches SW13/SW23, buffers A1/A2, positive input switches SW14/SW24, negative input switches SW15/SW25, a negative reference switch SW16, and a positive reference switch SW17; and the differential amplifier 60 includes a differential amplifier D1.

It is noted that, because the decoding control module 50 can simultaneously operate the analog data (sensing voltage) stored in two storage capacitors 41, the internal circuit shown in FIG. 2 includes two storage capacitors. In practice, the touch sensing apparatus 1 also includes the internal circuit having more than one set of storage capacitors, and the decoding control module 50 operates the analog data (sensing voltage) stored in each two storage capacitors, but the amount of the storage capacitors is not limited to the embodiment. In the present invention, the differential amplifier D1 of the touch sensing apparatus 1 has two input modes: one is a differential input mode; and the other is a single-ended input mode.

Firstly, illustrating the differential input mode of the differential amplifier D1. In a preset condition, the storage switches SW11/SW21, the buffer switches SW12/SW22, the ground switches SW13/SW23, the positive input switches SW14/SW24, the negative input switches SW15/SW25, the negative reference switch SW16, and the positive reference switch SW17 are all in open state.

The storage control module 40 receives the storage control signal transmitted from the logic control module 10, the storage control module 40 simultaneously controls the storage switch SW11/SW21 to be activated (i.e. in closed state) according to the storage control timing of the storage control signal, so that the analog data (including the first sensing voltage and the second sensing voltage) outputted from the driving/sensing control module 30 are respectively stored in the storage capacitors C1/C2. After the analog data sensed from the conductive thin film sensor 100 is stored in the storage capacitors C1/C2, the conductive thin film sensor 100 executes the discharge process, releasing the residual charge of the conductive thin film sensor 100.

The buffer switch SW12 is coupled with the storage capacitor C1, the ground switch SW13, and the buffer A1; and the buffer switch SW22 is coupled with the storage capacitor C2, the ground switch SW23, and the buffer A2. When the discharge process is completed, the logic control module 10 transmits the decoding control signal to the decoding control module 50. The decoding control module 50 controls the buffer switches SW12/SW22 to be activated (i.e. in closed state) and controls the ground switches SW13/SW23 deactivated (i.e. in open state), so that the analog data (including the first sensing voltage and the second sensing voltage) outputted from the storage capacitors C1/C2 is transmitted to the buffers A1/A2.

When the outputting process of the analog data of the storage capacitors C1/C2 is completed, the completed outputting process means that the differential amplifier D1 receives the first sensing voltage and the second sensing voltage. The differential amplifier D1 compares the first sensing voltage with the second sensing voltage and calculates a voltage variance between the first sensing voltage and the second sensing voltage in adjacent channel to output an amplified analog data to the analog/digital conversion module 70. In addition, the analog/digital conversion module 70 converts the amplified analog data into a plurality of digital data and transmits the digital data to the logic control module 10. The logic control module 10 controls the storage switches SW11/SW21 to be deactivated, controls the buffer switches SW12/SW22 to be activated, and controls the ground switches SW13/SW23 to be activated, so that the storage capacitors C1/C2 execute the discharge process to release the residual charge of the storage capacitors C1/C2.

In the present embodiment, the positive input switch SW12 and the negative input switch SW15 are coupled with the buffer A1 and the differential amplifier D1; the negative reference switch SW16 is coupled with the negative input switch SW15 and the differential amplifier D1; the other positive input switch SW24 and the other negative input switch 25 are coupled with the buffer A2 and the differential amplifier D1; and the negative reference switch SW16 is coupled with the negative input switch SW25 and the differential amplifier D1. When the decoding process is completed, the decoding control module 50 controls the positive input switch SW14 to be activated and controls the negative input switch SW15 to be deactivated, so that the first sensing voltage outputted from the buffer A1 is transmitted to the positive input end D11 of the differential amplifier D1. In the meantime, the decoding control module 50 controls the positive input switch SW24 to be deactivated and controls the negative input switch SW25 to be activated, so that the second sensing voltage outputted from the buffer A2 is transmitted to the negative input end D12 of the differential amplifier D1. When the differential amplifier D1 receives the first sensing voltage and the second voltage, the differential amplifier D1 will compare the first sensing voltage with the second voltage and will calculate a sensing voltage variance between the first sensing voltage and the second voltage to output the amplified analog data to the analog/digital conversion module 70. The analog/digital conversion module 70 converts the amplified analog data into the digital data and transmits the digital data to the logic control module 10.

In addition, the logic control module 10 also generates the control signals having different control timings, so that the first sensing voltage outputted from the buffer A1 is transmitted to the negative input end D12 of the differential amplifier D1, and the second sensing voltage outputted from the buffer A2 is transmitted to the positive input end D11 of the differential amplifier D1. The differential amplifier D1 receives the first sensing voltage and the second sensing voltage and compares the first sensing voltage with the second sensing voltage to calculate the voltage variance between adjacent channel, then the differential amplifier D1 outputs the amplified analog data to the analog/digital conversion module 70. The analog/digital conversion module 70 converts the amplified analog data into the digital data and transmits the digital data to the logic control module 10.

Moreover, illustrate the single-ended input mode of the differential amplifier. Please refer to FIG. 2, in a preset condition, the storage switches SW11/SW21, the buffer switches SW12/SW22, the ground switches SW13/SW23, the positive input switches SW14/SW24 are all in open state; the negative input switches SW15/SW25 are in open state permanently; the positive reference switch SW17 is in open state permanently, and the negative reference switch SW16 is in closed state permanently. In other words, the negative input end D12 of the differential amplifier D1 keeps coupling with the reference voltage (a steady voltage).

In the present embodiment, the positive input switch SW14 is coupled with the buffer A1 and the positive input end D11 of the differential amplifier D1. When the decoding process is completed, the decoding control module 50 controls the positive input switch SW14 to be deactivated; and the negative input switch SW15 is in open state permanently, and the negative reference switch SW16 is in closed state permanently, so that the first sensing voltage outputted from the buffer A1 is transmitted to the positive input end D11 of the differential amplifier D1. When the differential amplifier D1 receives the first sensing voltage, the differential amplifier D1 will compare the first sensing voltage with the reference voltage and will calculate a sensing voltage variance between the first sensing voltage and the reference voltage to output the amplified analog data to the analog/digital conversion module 70. The analog/digital conversion module 70 converts the amplified analog data into the digital data and transmits the digital data to the logic control module 10.

It is noted that, no matter the differential amplifier D1 of the touch sensing apparatus 1 utilizes the differential input mode or the single-ended input mode, the touch sensing apparatus 1 can operates the analog data by the differential amplifier D1 in the analog end to minimize the error of the analog data. It increases the accuracy of the digital data during amplifying and converting the digital data, and therefore minimizes the loading that the logic control module 10 operates the digital data in the digital end.

As shown in FIG. 2, in other embodiments, the positive reference switch SW17 is in closed state permanently, and the negative reference switch SW16 is in open state permanently. The positive input end D11 of the differential amplifier D1 keeps coupling with the reference voltage (a steady voltage), so that the sensing voltage is outputted to the negative end D12.

Compared to the prior arts, the touch sensing apparatus of the present invention simultaneously stores the analog sensing voltages sensed through the conductive thin film sensor in different storage capacitors, and the differential amplifier compares the analog sensing voltages of adjacent channel corresponding to different storage capacitors, so that the touch accuracy of the touch sensing apparatus increases according to the compared result of the sensing voltage. Moreover, the touch sensing apparatus of the present invention further utilizes the control signals having different control timings to perform the sensing process in a time period that the LCD panel does not generate noise, so that the misjudgment of the location of touch point due to the influence of the noise of liquid crystal display panel on the sensed data can be avoided.

In addition, because the conventional touch LCDs do not operate the analog data in the analog end, until the analog data is converted into the digital data, and then the logic control module operates the digital data, so that the error in the analog data cannot be reduced at first and the load of the logic control module is quite heavy. Hence, the touch sensing apparatus of the present invention utilizes the differential amplifier in the analog end operating the analog data to minimize the error of the analog data. When the analog data is amplified and is converted into the digital data, the accuracy of the digital data increases, so that the load of the logic control module decreases, further increasing the touch accuracy of the touch sensing apparatus.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A touch sensing apparatus, comprising:
a logic control module generating a plurality of control signals having different control timings, wherein the control signals comprise a decoding control signal;
a plurality of storage capacitors, wherein one of the storage capacitors at least stores a first sensing voltage and a second sensing voltage, the first sensing voltage and the second sensing voltage are analog data respectively sensed through a first sensing line and a second sensing line of a conductive thin film sensor;
at least one decoding control module coupled with the logic control module and the storage capacitors, wherein the decoding control module decodes according to a decoding control timing of the decoding control signal and outputs the first sensing voltage and the second sensing voltage; and
at least one differential amplifier coupled with the decoding control module, wherein the differential amplifier calculates a voltage variance between the first sensing voltage and the second sensing voltage to output an amplified analog data.

2. The touch sensing apparatus of claim 1, further comprising:
a plurality of pins; and
at least one driving/sensing control module coupled with the logic control module and the pins, wherein the driving/sensing control module receives a driving/sensing control signal of the control signals from the logic control module and controls the pins to execute a plurality of pin functions according to a driving/sensing control timing of the driving/sensing control signal, so that the pins sense the first sensing voltage and the second voltage from the first sensing line and the second sensing line of the conductive thin film sensor.

3. The touch sensing apparatus of claim 2, wherein the pin functions comprise a driving function, a sensing function, a grounding function, and a floating function.

4. The touch sensing apparatus of claim 2, wherein the logic control module generates the control signals having different control timings according to an external synchronization signal, so that the pins sense in a time period that a liquid crystal display panel does not generate noise during the pins sensing.

5. The touch sensing apparatus of claim 1, further comprising:
an analog/digital conversion module coupled with the differential amplifier and the logic control module, wherein the analog/digital conversion module converts the amplified analog data into a plurality of digital data and transmits the digital data to the logic control module.

6. The touch sensing apparatus of claim 5, wherein the logic control module comprises a digital filter for filtering the digital data to lower influence from a noise.

7. The touch sensing apparatus of claim 1, wherein a positive input end and a negative input end of the differential amplifier are coupled with the decoding control module and respectively receive the first sensing voltage and the second sensing voltage from the decoding control module.

8. The touch sensing apparatus of claim 1, wherein the positive input end of the differential amplifier is coupled with the decoding control module and receives the first sensing voltage from the decoding control module, and the negative input end of the differential amplifier is coupled with a ground end.

9. The touch sensing apparatus of claim 1, wherein the negative input end of the differential amplifier is coupled with the decoding control module and receives the first sensing voltage from the decoding control module, and the positive input end of the differential amplifier is coupled with the ground end.

10. The touch sensing apparatus of claim 1, further comprising:
at least one storage control module comprising the storage capacitors, wherein the storage control module is coupled with the logic control module and stores the first sensing voltage and the second sensing voltage in the one of the storage capacitors according to a storage control timing of a storage control signal of the control signals.
